(19) United States
(12) Patent Application Publication
(10) Pub. No.: US 2007/0264923 A1
(43) Pub. Date: Nov. 15, 2007

(54) Protection Device For Air-Flow Cabinets And Air-Flow Cabinet That Contains Said Device

(76) Inventors: Joan Cesar Galobardes, Terrassa (ES); Raul Clemente Montaner, Terrassa (ES)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/746,824

(22) Filed: May 10, 2007

Related U.S. Application Data
(60) Provisional application No. 60/747,029, filed on May 11, 2006.

(51) Int. Cl. B08B 15/00; B08B 15/02

(52) U.S. Cl. 454/56; 454/49

(57) ABSTRACT

It includes a frontal sliding window (6,6a), means for actuating said sliding window until a frontal working opening (5) has been closed at least partially, and a leaktightness seal (7) on the perimeter (8) of said opening (5), and is characterised in that said seal (7) is deformable elastically from a position in which the seal (7) is kept separated from said window (6,6a), to a position in which the seal (7) comes into contact with said window (6,6a), and in that it includes means (10,11,12,13,15) for deforming said seal (7). The device and the cabinet that includes it are very simple, safe and efficient.

The present invention relates to a protection device for air-flow cabinets and to air-flow cabinets that include said device.

### BACKGROUND OF THE INVENTION

Air-flow cabinets are items of laboratory equipment habitually used for handling biological and/or pharmaceutical products, ensuring protection of the product from exterior contamination, of the operative from interior contamination, or affording both protection at once.

The aforesaid cabinets have a working zone that is protected by four walls, the frontal one of which possesses an opening to facilitate operative access to said working zone, and a frontal glass window that partially covers the opening up to a certain height under which the operative gains access by inserting his/her arms to handle the sample. The aforesaid window acts as a protection barrier that further permits visual control of the sample being handled.

On certain occasions it may be necessary to close the frontal opening totally or partially, and leaktightly, in order for example to carry out decontamination of the working zone or to protect the operative from contamination in the event of an accident. On such occasions it can be very useful to fit such cabinets with a sliding glass window that is moved vertically up to the desired height or that completely closes off the opening.

With air-flow cabinets that use a sliding window, it is usual in order to ensure the leaktightness of the working zone to use a protection device that includes a seal of flexible material, such as silicone, attached to the perimeter of the frontal opening and against which the sliding window has necessarily to be pressed in order thereby to ensure sealing of the working zone.

This protection system or device has the disadvantage that, when it is wished to move the sliding window vertically in order to alter its height, this must in most cases be done manually, first moving the window horizontally towards the outside so that the glass pane is left free of the joint and can slide freely, otherwise the mechanism that actuates the window and the actual joint itself may be managed.

This double sliding, vertically and horizontally, to which the sliding window has to be submitted during sealing operations has a highly negative effect on its useful life, affecting both the mechanism that actuates the window and the security of the sealing operation itself. Over time, and owing to wear and tear of the mechanisms, the distance that separates the window from the seal does not remain constant at all points, so that the system must be checked at intervals if suitable leaktightness is to be guaranteed.

Moreover, the fact that for carrying out the sealing the sliding window must be slid in order to press it against the seal, usually manually, has the disadvantage of greatly hindering control of the sealing operation and the conditions under which said sealing is carried out, particularly in the event of accident. Further, pressing the window onto the seal tends to give rise to flexion-deformation of the glass that is a source of potential leakage points for contaminated air.

Another disadvantage of the protection devices of the state of the art lies in the fact that their security is connected with the quality of the very static seal they use. Thus, if for example said seal has any kind of defect (e.g. a small hole), the operative may not notice such a defect and may therefore become contaminated without being aware of it.

Another aspect to be taken into account is that most sliding windows used in air-flow cabinets are also fitted with an upper articulation of the hinging type that allows them to be raised completely so that they can be easily cleaned from their inner side. The nature of the aforesaid articulation can nevertheless have a negative effect on the protection of the cabinet, since the aforesaid point of articulation tends to destabilise the window glass and, therefore, to affect the quality of the sealing operation itself.

### DESCRIPTION OF THE INVENTION

The objective of the present invention is to resolve the disadvantages mentioned by developing a protection device for air-flow cabinets, and an air-flow cabinet that includes said device, which are very simple from a constructional viewpoint and much more secure and efficient than the devices and cabinets of the state of the art.

In accordance with this objective, the device of the present invention includes a sliding frontal window, means for actuating said sliding window until a frontal working opening is at least partially closed, and a leaktightness seal on the perimeter of said opening, and is characterised in that said leaktightness seal is a seal elastically deformable from a position in which the seal is kept separated from said window, to a position in which the seal comes into contact with said window, and in that it includes means for deforming said seal.

Thanks to the characteristics of the device of the present invention, when the sealing operation is carried out the sliding window and the mechanism that actuates it does not have to be moved in order to press on the leaktightness seal, but rather it is the seal itself that is deformed, moved and adapted to make contact under suitable pressure with the window glass. Thus after a time, the number of movements the window makes is very much lower, which has a very positive effect both on the useful life of the window itself and of the mechanism that actuates it, as well as on the safety of the sealing operation. The constructional simplicity of the device claimed allows a constant distance over time to be ensured between the window and the perimeter of the frontal working opening, thereby facilitating control of the conditions under which the sealing and the device work, and making the cabinet that contains it more secure.

Another advantage of the device claimed lies in the fact that the sealing operation is carried out when the means for deforming the seal act and, therefore, without need for the operative to intervene manually by pressing the window against onto seal. Thus, with the device of this invention, when the window reaches the desired working height, or in the event of an accident, the means that deform the seal actuate immediately, providing the necessary level of leaktightness and preventing the window from being moved accidentally. If this does not occur, a control system can warn the operative so that the latter may take the necessary preventive measures. Similarly, when the operative has finished the work and goes to actuate the window to move it vertically, the device actuates to separate the seal of the window immediately, thus protecting the mechanism that actuates the window, or the seal itself, from damage.

Preferably, said device includes means for controlling the contact pressure of said seal on said window. It is thereby possible to ensure a certain level of leaktightness, beneath which the alarm systems can operate to warn the operative.

Also preferably, said seal includes a cavity, thus making it easier for the seal to deform elastically.

According to a preferred embodiment, at least the upper wall of said cavity is deformable elastically from a position in which said wall is folded back inside said cavity, to a position in which the wall makes contact with said window. This arrangement of the seal has the advantage that it occupies little space, and is therefore very advantageous for applying on the narrow perimeter of the frontal openings of air-flow cabinets.

Preferably, also according to the same embodiment, said means for deforming the seal include means for supplying a fluid under pressure into the interior of said cavity. Deformation of the seal is thereby carried out conveniently. Thus, when it is wished to deform the seal to seal the window, fluid is fed under pressure into the cavity with the result that the seal deforms elastically in such a way that the upper wall of the cavity makes contact with the window under pressure. On the other hand, when it is wished to move the window, the pressure of the fluid is made to fall until the seal returns to its initial position in which the upper wall of the cavity ceases to make contact with the window.

Again preferably, said means for controlling the pressure include a pressure sensor that, advantageously, measures the fluid pressure of the seal. It is thus very easy to set and to control maximum and minimum fluid-pressure values, measured by said sensor, above and below which suitable contact and separation of the seal with the window, respectively, will be ensured.

Advantageously, said device includes a battery for supplying energy at least to said means for elastically deforming said seal. The device can thereby ensure the leaktightness of the frontal working opening, for example in the event of power outage or of the protection device being disconnected.

### BRIEF DESCRIPTION OF THE DRAWINGS

For a better understanding of all that has been set out some drawings are attached that show, schematically and solely by way of non-restrictive example, a practical case of embodiment.

In said drawings,

FIG. 1 is a general perspective view of an air-flow cabinet provided with the device claimed.

FIG. 2 is a perspective view of the cabinet of FIG. 1, showing the frontal working opening.

FIG. 3 is a perspective view of the cabinet of FIG. 1, showing the sliding window partially closing the frontal working opening.

FIG. 4 is a detail view of the opening shown in FIG. 2, in which the leaktightness seal can be observed.

FIGS. 5a and 5b are schematics view that shows a section of the seal fixed in the perimeter of the opening of the cabinet, in its two working positions.

### DESCRIPTION OF A PREFERRED EMBODIMENT

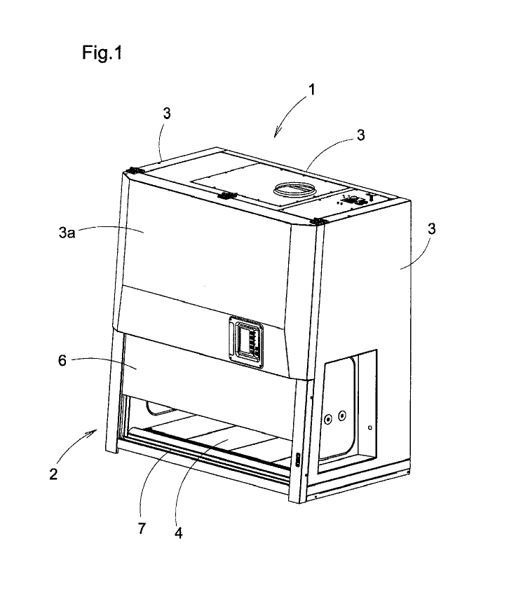

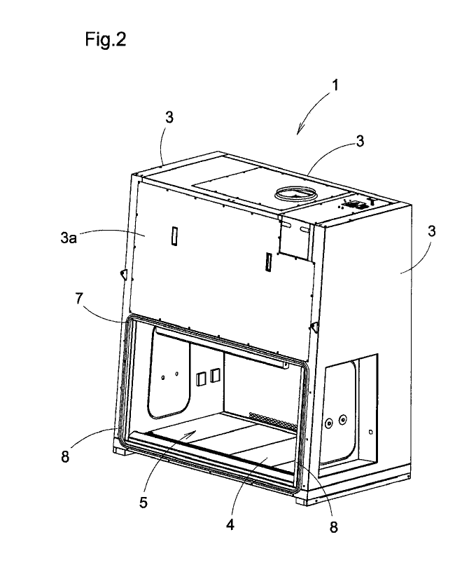

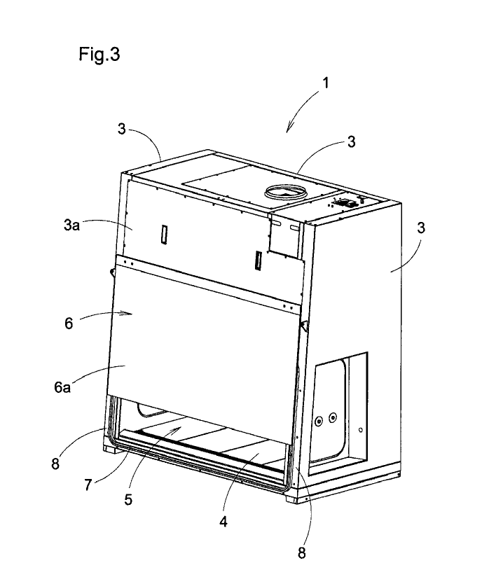

FIGS. 1 to 4 show an air-flow cabinet 1 of the type normally used for handling biological and pharmaceutical products, which the claimed device 2 contains.

As can be seen from the aforesaid figures, the cabinet 1 is provided with four vertical walls 3 that form a working zone 4 provided with a vertical laminar air flow that ensures at least protection of the product and of the operative.

The cabinet protection device 2 is mounted on the frontal wall 3a of said cabinet 1 in which is mounted the opening 5 that permits access to the working zone 4.

Said device 2 includes a sliding window 6 that permits the aforesaid opening 5 to be closed totally or partially, and an elastically deformable leaktightness seal 7, fixed onto the perimeter 8 of the opening 5. In the embodiment described the window 6 is actuated automatically by means of an automatic mechanism that is not shown. Said window 6 can nevertheless also be actuated manually. The window 6 has a transparent pane 6a that allows the operative to view the sample while manipulating it under the window 6, when the latter remains open at a certain height.

Although this has not been show, the window 6 itself can be provided with a hinged raising system that allows it be cleaned from both sides.

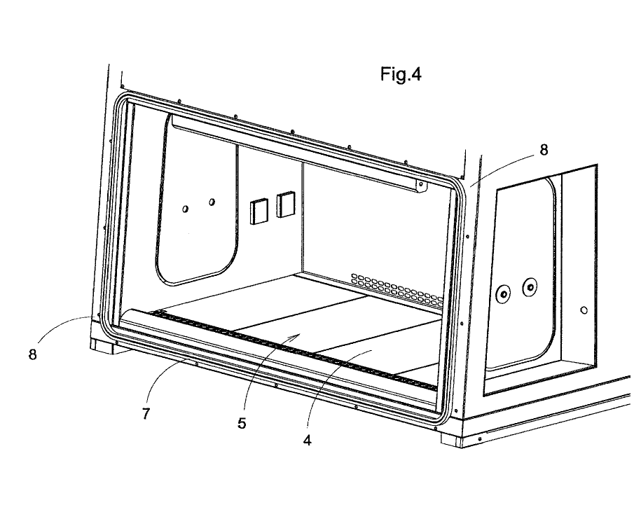

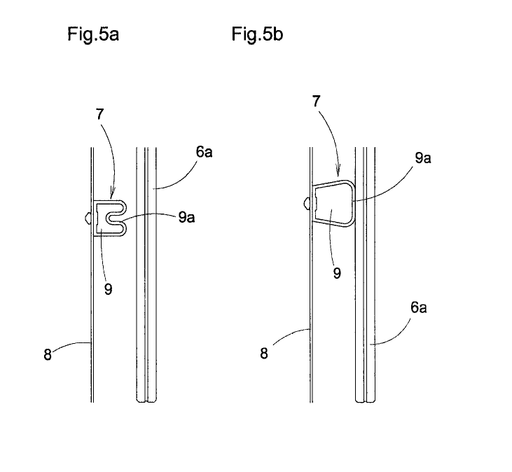

As can be seen in FIGS. 5a and 5b, the seal 7 includes a cavity 9 with an upper wall 9a. The aforesaid seal 7 is deformable elastically from an initial position in which the wall 9a is folded back inside the cavity 9, to a position in which said wall 9a comes into contact with the glass pane 6a of the window 6. FIG. 4 shows a detail of the frontal wall 3a of the cabinet 1 with the seal 7 attached to the perimeter 8 of the opening 5. In this figure, the seal 7 is in the position in which the wall 9a is folded back into the interior of the cavity 9, keeping the glass separate 6a.

In the embodiment described, the elastic deformation of the seal 7 is carried out by means of a system 10 that feeds fluid 11 at a particular pressure to the interior of the cavity 9. Said system 10 includes at least one fluid pump 12 or other equivalent part that can cause the fluid 11, preferably, air, to circulate at a certain pressure through the interior of the aforesaid cavity 9 of the seal 7 until it has been deformed elastically. The pump 12 is connected by means of filtering devices 13 to pressure sensors 14 and electrically operated valves 15 that control the supply of fluid 11 and the pressure of fluid 11 from the circuit.

There follows a description of the operation of the device 2 of the present invention.

In order to carry out the sealing operation, whether when the window 6 is in position for use, moved vertically up to a certain height, or fully shut, as for decontaminating the working zone 4, the pump 12 is actuated and also the corresponding electric valve 15 to intake of fluid 11 up to the pressure of the seal 7, measured by a pressure sensor 14, reaches a predetermined value that provides suitable contact pressure of the seal 7 with the glass pane 6a of the window 6 (see FIG. 5b).

When the operative needs to change the vertical working position of the window 6, the pump 12 is actuated again and, in this case, also the corresponding electric valve 15 to fluid 11 outlet up to the pressure of the seal 7, measured by the sensor 14, reaches the predetermined value for which said seal 7 remains separated from the pane 6a of the window 6 (see FIG. 5a).

In both the cases described, the time taken to reach the predetermined pressure values of the seal 7 is controlled by the main control system 16 of the device 2, which warns the operative if that time is longer than required, thereby indicating poor operation of the device 2.

The device 2 of the embodiment described is also provided with a built-in auxiliary battery 17 that allows the sliding window 6 to be slid into leaktight position in the event of power outage.

Surprisingly, the device 2 of the present invention enables speedy, simple and enormously secure sealing of air-flow cabinets 1, so that the cabinets 1 on which said device 2 are applied offer a high level of safety in relation to the cabinets of the state of the art.

In spite of the fact that one specific embodiment of the present invention has been described and shown, an expert in the subject would clearly be able to introduce variants and modifications, or to replace details by others that are technically equivalent, without departing from the scope of protection defined by the attached claims.

1. Protection device for air-flow cabinets (1) that includes a sliding frontal window (6,6a), means for actuating said sliding window until a frontal working opening (5) is at least partially closed, and a leaktightness seal (7) on the perimeter (8) of said opening (5), wherein said seal (7) is deformable elastically from a position in which the seal (7) is kept separated from said window (6,6a), to a position in which the seal (7) comes into contact with said window (6,6a), and in that it includes means (10,11,12,13,15) for deforming said seal (7).

2. Device according to claim 1, wherein it includes means (14,16) for controlling the contact pressure of said seal (7) on said window (6,6a).

3. Device according to claim 1, wherein said seal (7) includes a cavity (9).

4. Device according to claim 3, wherein at least the upper wall (9a) of said cavity (9) is deformable elastically from a position in which said wall (9a) is folded back in the interior of said cavity (9), to a position in which the wall (9a) comes into contact with said window (6,6a).

5. Device according to claim 3, wherein said means for deforming said seal comprise means (10,12,13,15) for supplying fluid (11) under pressure into the interior of said cavity (9).

6. Device according to claim 2, wherein said means for controlling the pressure include a pressure sensor (14).

7. Device according to claim 1, wherein it includes a battery (17) for supplying energy at least to said means (10,11,12,13,15) for elastically deforming said seal (7).

8. Air-flow cabinet wherein it includes a device (2) according to claim 1.
